(19) United States
(12) Patent Application Publication
(10) Pub. No.: US 2009/0191093 A1
(43) Pub. Date: Jul. 30, 2009

(54) BIOCHEMICAL TEST STRIP

(75) Inventors: Ying-Che Huang, Jhonghe City (TW); Mon Wen Yang, Hsinchu City (TW); Jui-Ping Wang, Hsinchu City (TW); Thomas Y.S. Shen, Hsinchu City (TW)

Correspondence Address: SNELL & WILMER L.L.P. (Main), 400 EAST VAN BUREN, ONE ARIZONA CENTER, PHOENIX, AZ, 85004-2202, US

(73) Assignee: APEX BIOTECHNOLOGY CORP., Hsinchu City (TW)

(21) Appl. No.: 12/356,395

(22) Filed: Jan. 20, 2009

(30) Foreign Application Priority Data
Jan. 24, 2008 (TW) 97201576

(51) Int. Cl. G01N 27/00

(52) U.S. Cl. 422/56

(57) ABSTRACT

A biochemical test strip is provided. The biochemical test strip includes an insulating substrate, an electrode system, an insulating layer, and a cover. The electrode system is formed on the insulating substrate and the insulating layer is formed on the electrode system. The insulating layer has an opening, and the opening exposes a part of the electrode system to define a reaction region with a supply port. The cover is formed above the insulating layer to cover the reaction region and has a slot corresponding to the reaction region and a sampling hole corresponding to the supply port.

### CROSS REFERENCE TO RELATED APPLICATIONS

This application claims the right of priority based on Taiwan Patent Application No. 097201576 entitled “BIOCHEMICAL TEST STRIP,” filed on Jan. 24, 2008, which is incorporated herein by reference and assigned to the assignee herein.

### FIELD OF INVENTION

The present invention relates to a biochemical test strip, and more particularly, to a biochemical test strip being easily made and with enhanced analysis accuracy.

### BACKGROUND OF THE INVENTION

With the advance of the medical science and the rising concept from the modern people about health care, the Point-of-Care (POCT) has been widely available to the market. Such kinds of self-testing products, such as blood glucose monitor, electrical ear thermometer, and electrical sphygmomanometer, tend to be fast, cheap, small and getting rid of professional help for the operation. In such fields, the use of the biochemical test strip is a well-versed skill, especially for the popular application of monitoring the blood glucose.

The conventional biochemical test strip is formed with a circular vent on the cover and the diameter of the circular vent is normally above 1 mm. In the conventional biochemical test strip as disclosed in U.S. Pat. No. 5,997,817 and U.S. Pat. No. 6,969,450, a sample liquid is absorbed by way of capillary action from the supply port into a reaction region and reacts with reagents located at the reaction region. Then, the conventional biochemical test strip is electrically connected to a measurement device for generating a test signal. Through the microprocessor in the measurement device, the test signal is converted into data indicating the amount of the inspected substance, which will be displayed on a monitor of the measurement device.

The scale of the reaction region of the biochemical test strip is getting decreased for the needs of trace sampling and short time analysis applications. As the reaction region becomes smaller but the size of the vent remains the same, the vent will be relatively too large, and cause a disturbing flow phenomenon toward the adhesive liquid sample being introduced into the reaction region. The phenomenon will make the liquid sample unable to stop rapidly, such that a testing might be conducted during an unsteady state of the liquid sample. This will adversely affect the analysis accuracy and lead to an incorrect test signal. On the other hand, one may consider decreasing the size of the vent with the same ratio for decreasing the reaction region. In such a way, the vent might become too small to provide sufficient ventilations and thus the sampling would still fail.

Accordingly, it is desirable to provide a biochemical test strip with an improved vent for resolving the above-described problems.

### SUMMARY OF THE INVENTION

In view of the problems existing in the prior art, the present invention provides a biochemical test strip with enhanced analysis accuracy and available for trace sampling.

One aspect of the present invention is to provide a biochemical test strip comprising an insulating substrate; an electrode system disposed on the insulating substrate; an insulating layer disposed on the electrode system, the insulating layer having a first opening to expose a part of the electrode system to define a reaction region with a supply port; and a cover disposed on the insulating layer to cover the reaction region, the cover having a slot corresponding to the reaction region and a sampling hole corresponding to the supply port.

According to one embodiment of the present invention, the cover is featured in having the slot corresponding to the reaction region for the help of sample distribution on the reaction region. The slot can be shaped as a straight line, an arc, or any other style including combinations of multiple lines, such as a cross or a concave shape. The slot may further include an r angle at the crossing point of any two lines. Unlike the conventional circular vent, the slot of the present invention is streamlined. As the reaction region becomes smaller, the streamlined slot, rather than the conventional circular vent, allows air in an adequate amount to flow through without incurring the undesired disturbing flow phenomena or ventilation insufficiency problems.

Various aspects of the present invention will be described in the following description; part of them will be apparent from description and others can be known from the execution of the present invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE PICTURES

The foregoing aspects and many of the attendant advantages of this invention will become more readily appreciated as the same becomes better understood by reference to the following detailed description, when taken in conjunction with the accompanying pictures, wherein:

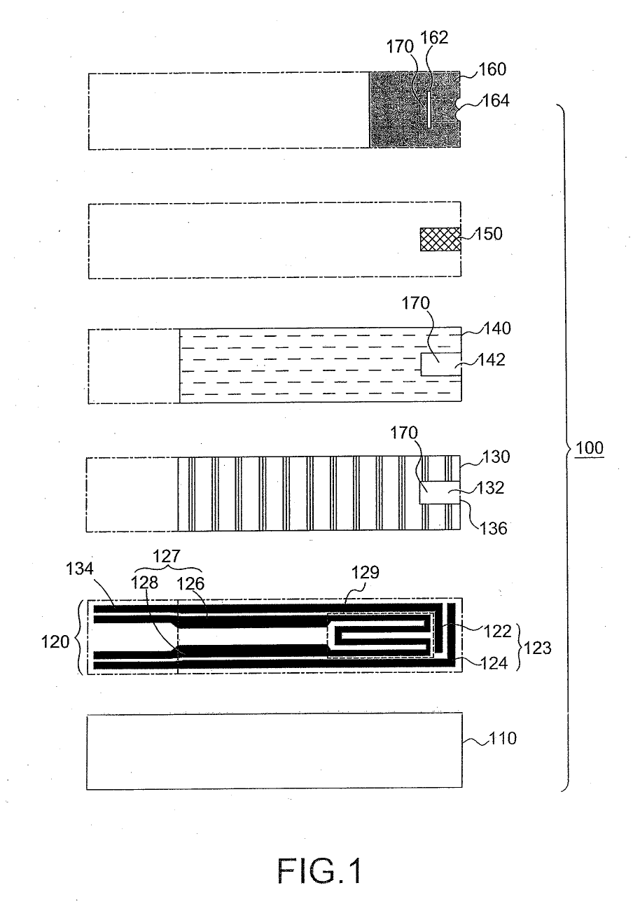

FIG. 1 illustrates an explosive view of a biochemical test strip in accordance with one embodiment of the present invention.

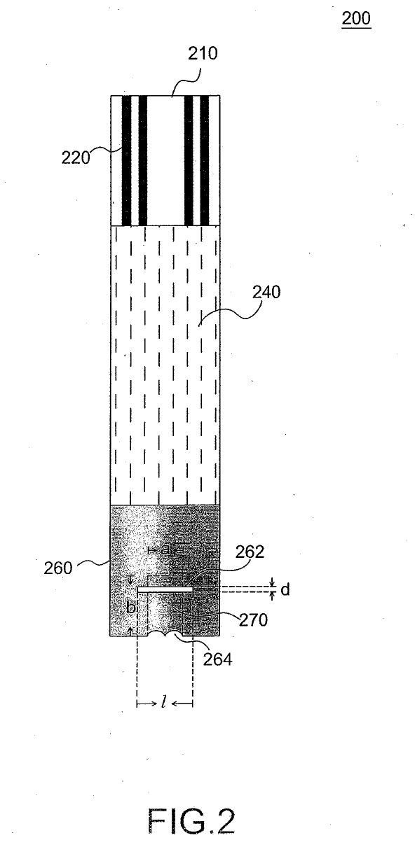

FIG. 2 illustrates a top view of a biochemical test strip being assembled with layers similar to those illustrated in FIG. 1.

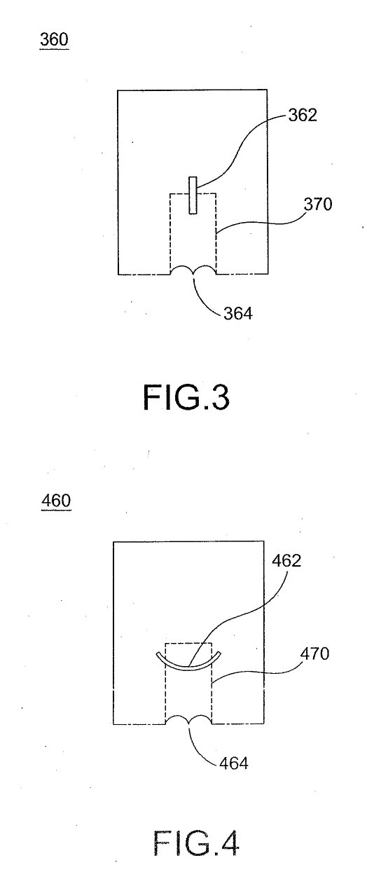

FIGS. 3 to 7 illustrate the covers of the biochemical test trips in accordance with other embodiments of the present invention.

### DETAILED DESCRIPTION OF THE INVENTION

The present invention discloses a biochemical test strip with enhanced analysis accuracy. The preferred embodiments of the present invention will now be described in greater details by referring to FIGS. 1-7 that accompany the present application, wherein similar elements are represented with like reference numerals. It should be noted that the features illustrated in the drawings are not necessarily drawn to scale. Descriptions of well-known components, materials, and process techniques are omitted so as to not unnecessarily obscure the embodiments of the invention. Any devices, components, materials, and steps described in the embodiments are only for illustration and not intended to limit the scope of the present invention.

FIG. 1 illustrates an explosive view of a biochemical test strip 100 in accordance with one embodiment of the present invention wherein the broken line indicates the relative positions between various elements. The biochemical test strip 100 includes an insulating substrate 110, an electrode system 120, an insulating layer 130, a separation layer 140, a reaction layer 150 and a cover 160.

The insulating substrate 110 is electrically insulating, and its material can include but not limit to: polyvinylchloride (PVC), glass fiber (FR-4), polyester, bakelite, polyethylene terephthalate (PET), polycarbonate (PC), polypropylene (PP), polyethylene (PE), polystyrene (PS), or ceramic material.

The electrode system 120 can be made with any conductive materials such as carbon paste, gold-silver paste, copper paste, carbon silver paste, other similar materials or combinations thereof. In one embodiment, the electrode system 120 is composed of a conductive silver paste layer and a conductive carbon paste layer disposed on the conductive silver paste layer. The electrode system 120 includes a set of testing electrodes 123, a set of identifying electrodes 127 and a resistor 129. The set of testing electrodes 123 includes a reference electrode 122 and a working electrode 124 electrically insulated from the reference electrode 122. The set of identifying electrodes 127 includes a first identifying electrode 126 and a second identifying electrode 128 in connection with the first identifying electrode 126 through the resistor 129. Typically, it's sufficient as each electrode in a reaction region follows the arrangement order as mentioned above. The present invention is not limited to specific arrangements of the set of testing electrodes 123 and the set of identifying electrodes 127, or the exact number of electrodes. Additional electrodes may be provided according to different application needs. The electrode system further defines a connection region 134 for electrically connecting the electrode system with a measurement device (not shown).

The insulating layer 130 is disposed on the electrode system 120, and includes a first opening 132 to expose a part of the conductive layer 120. In addition, as shown in FIG. 1, the size of the insulating layer 130 is less than the insulating substrate 110, and thus the connection region 134 of the electrode system 120 will be exposed when the insulating layer 130 is disposed on the electrode system 120. The first opening 132 defines a reaction region 170 having a supply port 136. The size of the first opening 132 is preferably sufficient to expose part of the working electrode 124 and part of the reference electrode 122. The present invention is not intended to limit the shapes of the first opening 132 and the supply port 136. Besides, the material of the insulating layer 130 can include but not limited to: PVC insulating tape, PET insulating tape, thermal drying insulating paint or ultraviolet drying insulating paint.

Still referring to FIG. 1, a separation layer 140 is disposed on the insulating layer 130. The separation layer 140 is electrically insulating and formed with a second opening 142 corresponding to the first opening 132. The size of the separation layer 140 is also less than the insulating substrate 110, and thus the connection region 134 will be exposed when the separation layer 140 is disposed on the insulating substrate 110. The cover 160 is disposed on the separation layer 140, covering the first opening 132 and the second opening 142. The first opening 132 and the second opening 142 between the insulating substrate 110 and the cover 160 form a sampling space (i.e. the reaction region 170). The size of the sampling space depends upon the thicknesses of the separation layer 140 and the insulating layer 130. In another embodiment of the present invention, the separation layer 140 may not exist and thus the size of the sampling space depends upon the thickness of the insulating layer 130. Generally, the thickness of the insulating layer 130 is between 0.005 and 0.3 millimeter, but not limited thereto. Furthermore, during the procedure of manufacturing multiple biochemical test strips 100, by way of cutting, the multiple first openings 132 are formed in a large sheet of the insulating layer 130 prior to disposing the insulating layer 130 onto the insulating substrate 110 and the conductive layer 220 forms. Alternatively, by way of printing, the insulating layer 130 with the pattern of the multiple first openings 132 may be formed concurrently onto the insulating substrate 110.

In the embodiment, the sample liquid is provided to the reaction region 170 from the supply port 136, which will then contact the set of testing electrodes 123 and the set of identifying electrodes 127. When the biochemical test strip 100 is inserted into the measurement device (not shown), a loop is formed between the first identifying electrode 126, the second identifying electrode 128, the resistor 129 and the measurement device, such that the measurement device is activated. Then, in order to determine correctness of the biochemical test strip, the measurement device will detect the resistance between the first identifying electrode 126 and the second identifying electrode 128 and compare it with the resistance of the resistor 129. Also, the measurement device will detect the change of the resistance between the reference electrode 122 and the working electrode 124 in order to determine whether the sample liquid has been provided to the reaction region.

In the illustrated embodiment, the biochemical test strip 100 further includes a reaction layer 150 disposed within the first opening 132. The reaction layer 150 is made of materials used for identifying specific organisms or signals. The materials of the reaction layer 150 can vary with sample types. For example, the reaction layer 150 can include oxidoreductases for reacting with the sample. Generally, the reaction layer 150 covers a part of the working electrode 124 and a part of the reference electrode 122.

In the embodiment, the cover 160 can be transparent or translucent, so that the users may check whether the sample has been placed on the reaction region 170 for avoiding a false result. The lower surface of the cover 160 close to the reaction region 170 can be coated with a hydrophilic material to enhance the capillary action on the inner wall of the reaction region. In this way, the sample can be conducted to the reaction region more quickly and efficiently.

In addition, for enlarging the area for absorbing the sample, the cover 160 further includes a sampling hole 164 corresponding to the supply port 136, in order to facilitate the adsorption of the sample. The sample hole 164 can be formed with at least one indentation on the edge of the cover 164. The shape of the indentation is not limited. As shown in FIG. 1 of the embodiment, the sample hole 164 is formed with two semicircle shaped indentations. In other embodiments, the sampling hole 164 may be formed with one or more than one indentation shaped in semi-ovals, squares, triangles and any combinations thereof. According to the embodiment, the sample hole 164 not only increases the sample adsorption area, but also provides more sampling ways. That is, the sampling can either be conducted along the lateral side of the biochemical test strip 100 or from the topside thereof. In other words, the sampling way for the biochemical test strip 100 is not restricted by a single direction. Furthermore, as being frequently seen in conventional test strips, the failures of sealing the supply port due to adhesion gels occurs when stamping or precutting the conventional test strips is performed. The adhesion gels block the supply port and thus the sampling is unable to conduct. As for the present invention, by way of forming the indentation at the supply port, the possibility of such failures can be reduced.

In order to further enhance the capillary action, the cover 160 further includes a streamlined slot 162 corresponding to the reaction region 170 for expelling the air inside the reaction region. Generally, the slot 162 is nearer the back end of the reaction region 170. The shapes of the slot 162 are various. For example, the slot 162 can be shaped as a straight line, an arc, etc. The different shapes of the slot 162 will be described later.

FIG. 2 depicts a top view of a biochemical test strip 200 that is assembled with layers being structured similar to those illustrated in FIG. 1. As shown in FIG. 2, the electrode system 220 is disposed on the insulating substrate 210 and the separation layer 240 covers part of the electrode system to expose one end of the electrode system 220 so as to electrically connect the measurement device. The cover 260 includes a slot 262 corresponding to the reaction region 270 (as shown in broken line) that is created by the first opening 132 and the second opening 142. The cover 260 also includes a sampling hole at the supply port 264 of the reaction region 270. The sampling hole is intended to increase the sample adsorption area as well as reduce the possibility of manufacturing failure due to the undesired sealing caused by adhesion gels when stamping or precutting the test strips is performed.

As shown in FIG. 2, the cover 260 includes a slender slot 262 having a longitudinal side parallel with the supply port 264. The reaction region 270 is formed with a width a less than about 2 mm and a length b less than about 8 mm. The slot 262 is formed with a width d less than 1 mm and more than 0 mm. In one preferred embodiment, the width d of the slot 262 is between 0.5 mm and 0.01 mm as the width a of the reaction region 270 is around 1.4 mm and the length b of the reaction region 270 is around 4 mm. Preferably, for better air expelling, the length l of the slot 262 is equal to or more than the width a of the reaction region 270. As shown in FIG. 2, there are a part of the slot 262 corresponding to the reaction region 270 and another portion thereof not corresponding to the reaction region 270. Notes that preferably, the part of the reaction region 270 corresponding to the slot 262 is located away from the supply port 264.

FIGS. 3 to 8 illustrate the covers of the biochemical test trips in accordance with other embodiments in the present invention. In the embodiment of FIG. 3, the cover 360 includes a vertical slot 362, having a longitudinal side arranged as vertical to the supply port 364. Note that preferably, the part of the reaction region 370 corresponding to the vertical slot 362 is located away from the supply port 364. Further, there is a part of the vertical slot 362 corresponding to the reaction region 370 and another part thereof not corresponding to the reaction region 370. According to other embodiments, the slot can be arranged in a slanting position, rather than horizontal or perpendicular relative to the supply port.

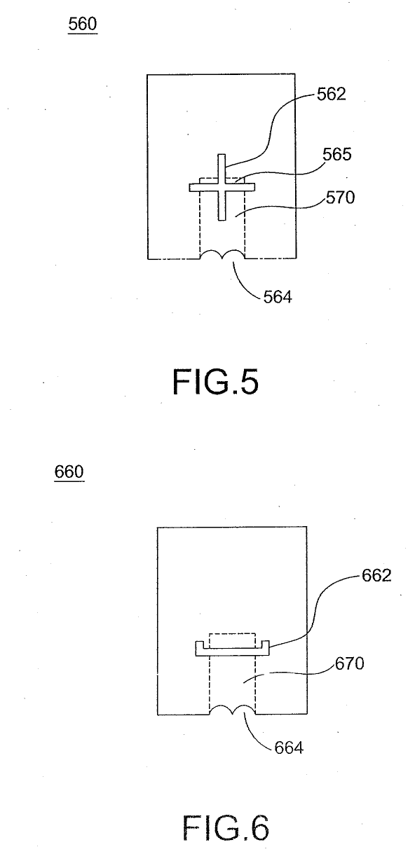

In the embodiment of FIG. 4, the cover 460 includes an arc-shaped slot 462. Likewise, a part of the reaction region 470 corresponding to the arc-shaped slot 462 is located away from the supply port 464. Further, there is a part of the arc-shaped slot 462 corresponding to the reaction region 470 and another part thereof not corresponding to the reaction region 470. In the embodiment of FIG. 5, the cover 560 includes a cross-typed slot 562. Likewise, a part of the reaction region 570 corresponding to the cross-typed slot 562 is located away from the supply port 564. Further, there is a part of the cross-typed slot 562 corresponding to the reaction region 570 and another part thereof not corresponding to the reaction region 570. In the embodiment of FIG. 6, the cover 660 includes a concave-shaped slot 662. Likewise, a part of the reaction region 670 corresponding to the concave-typed slot 662 is located away from the supply port 664. Further, there is a part of the cross-typed slot 662 corresponding to the reaction region 670 and another part thereof not corresponding to the reaction region 670. The shapes of the slots as aforementioned are provided for illustration, not limitation. According to other embodiments, the slots can be Y-typed, cross-arc, patterned with multiple straight lines, or any combinations thereof.

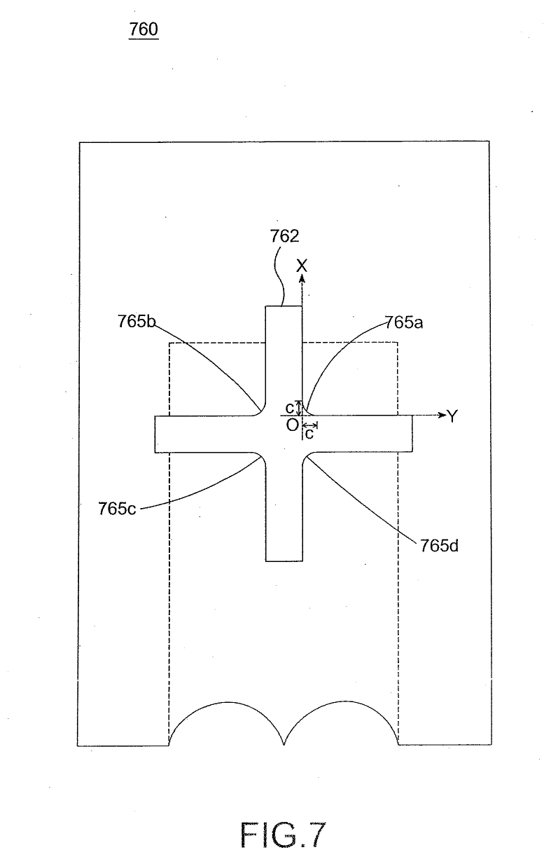

In the embodiments of FIG. 7, a cross-typed slot 762 is illustrated. Unlike the cross slot 562 of FIG. 5, having right angles 565 with sharp edges at the crossing center thereof, the cross slot 762 of FIG. 7 is formed with four r angles 765a, 765b, 765c, 765d having smooth edges at the crossing center thereof. The definition of the so-called “r angle” can refer to a CAD/CAM plotting system, for example, AutoCAD®. Namely, as shown in FIG. 7, the curving degree of the r angle can be defined by a tangent line segment C that is derived by extending the a line from the cross point O of the straight lines X and Y along the direction of X or Y. As to the four r angles 765a, 765b, 765c, 765d of the embodiment of FIG. 7, the length of the tangent line segment C is preferably ranged between 0.05 mm and 0.5 mm, more preferably being 0.2 mm. In another embodiments, r angles can be formed at a cross point of any two lines. The benefit of the r angle is the help of air venting. The more the tangent line segment C is, the more the help of air venting gets. Note that FIG. 7 illustrates the four r angles 765a, 765b, 765c, 765d being formed with the same curving degrees while in another embodiment of a cross slot, four r angles with different curving degrees can be formed.

According to the above descriptions, it should be understood that the biochemical test strips of the present invention can satisfy the requirements in tracing sampling and short time analysis applications. With the biochemical test strips of the present invention, the analysis accuracy is enhanced due to the benefits of instantly introducing the inspected sample into the reaction layer and eliminating the disturbing flow phenomenon caused by conventional vents. Furthermore, the present biochemical test strips also provide additional sampling ways and increase the sample adsorption area. In the meantime, the present invention further provides observable identification features on the biochemical test strips so that the convenience for user is further improved.

The above illustration is for preferred embodiments of the present invention; it should not limit the claims of the present invention. Equivalents and modifications without departing from the spirit of the invention should be included in the scope of the following claims.

1. A biochemical test strip, comprising:
an insulating substrate;
an electrode system disposed on the insulating substrate;
an insulating layer disposed on the electrode system, the insulating layer having a first opening to expose a part of the electrode system to define a reaction region with a supply port; and
a cover disposed on the insulating layer to cover the reaction region, the cover having a slot corresponding to the reaction region and a sampling hole corresponding to the supply port.

2. The biochemical test strip of claim 1, wherein the slot is shaped as a straight line, an arc, a cross, or a concave shape.

3. The biochemical test strip of claim 2, wherein the slot is shaped as a straight line and is perpendicular to the supply port.

4. The biochemical test strip of claim 2, wherein the slot is shaped as a straight line and is horizontal to the supply port.

5. The biochemical test strip of claim 2, wherein the slot is shaped as a straight line and is in a slanting position, rather than horizontal or perpendicular, relative to the supply port.

6. The biochemical test strip of claim 1, wherein the slot has a width ranged between 0 mm and 1 mm.

7. The biochemical test strip of claim 6, wherein the reaction region has a width less than 2 mm and a length less than 8 mm.

8. The biochemical test strip of claim 7, wherein the width of the reaction region is 1.4 mm, the length of the reaction region is 4 mm, and the width of the slot is between 0.01 mm and 0.5 mm.

9. The biochemical test strip of claim 2, wherein the slot is shaped as a cross including an r angle and a curving degree of the r angle depends upon a tangent line segment defined by a plotting system.

10. The biochemical test strip of claim 9, wherein the tangent line segment is ranged between 0.05 mm and 0.5 mm.

11. The biochemical test strip of claim 9, wherein the tangent line segment is 0.2 mm.

12. The biochemical test strip of claim 1, wherein a length of the slot is larger than a width of the reaction region.

13. The biochemical test strip of claim 1, wherein the supply port is located at a side of the reaction region, and the reaction region further comprises another side corresponding to the slot and away from the supply port.

14. The biochemical test strip of claim 1, wherein the slot comprises a part corresponding to the reaction region and another part not corresponding to the reaction region.

15. The biochemical test strip of claim 1, wherein the insulating layer has a thickness ranged between 0.005 mm and 0.3 mm.
